(19) United States
(12) Patent Application Publication
(10) Pub. No.: US 2003/0227998 A1
(43) Pub. Date: Dec. 11, 2003

(54) X-ray image sensory system

(76) Inventor: Kuo-Fu Liao, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/162,868

(22) Filed: Jun. 6, 2002

(51) Int. Cl. H05G 1/64

(52) U.S. Cl. 378/98.8

(57) ABSTRACT

An X-ray image sensory system includes an x-ray conversion module for converting input x-rays, an image sensory component connected to the conversion module for detecting the converted signals, a substrate board, a buffer, and an analog-to-digital converter. The X-ray conversion module and the image sensory component are on the side of the substrate board facing the input X-ray, and the buffer and the analog-to-digital converter are on the other side of the substrate board. Each of above components is manufactured respectively, thereafter disposed on the substrate board.

### BACKGROUND OF THE INVENTION

1. Field of the Invention

The present invention relates to an X-ray image sensory system, and, more particularly, to an X-ray image sensory system placing its components which are more susceptible to the X-ray on the other side of the substrate board to avoid damages.

2. Description of Prior Arts

Prior art X-ray sensory systems employ films to display the X-ray images, and as this result, about tens of minutes have to be taken to obtain a picture. In the process of exposure, transportation, processing and printing, the picture on film is susceptible to damages. If that happens, the whole process has to be repeated again from the beginning.

The contemporary X-ray image sensory system is digital-based. The image can be displayed on a screen in a matter of a few seconds. If any mistake occurs during the process, the new image can be taken immediately. Digital X-ray image sensory systems frequently adopt Charge Coupled Device (CCD), or Complementary Metal Oxygen Semiconductor (CMOS) for their image sensory components. In comparison, CCD is more sensitive to the X-ray, but has a lower tolerance to the X-ray damage. On the other hand, CMOS has a higher tolerance to the X-ray, and is easy for mass production as it is the mainstream in semiconductor fabrication. Furthermore, because the CMOS components are usually small in terms of area size, it is possible to manufacture the entire X-ray sensory system on a single chip, namely, the so-called System On Chip (SOC).

However, because the components of X-ray image sensory system are with different tolerances to the X-ray, it is possible that some components are more susceptible to the X-ray damage if they are all exposed to the same amount of X-ray. Furthermore, when the X-ray image sensory system is used in the dental checkup, the entire system needs to be placed inside the patient's mouth. This has imposed a strong limitation of the size of the system, which, in turn, limits the possible shields for the components less tolerant to the X-ray. One possible solution is to increase the distance between the less tolerant components and the sensory components to avoid the direct exposure while taking the image. However, this solution has the disadvantage of signal decay due to the longer transmission distance, and greater distortion due to the signal interference.

### SUMMARY OF THE INVENTION

It is therefore a primary objective of the present invention to provide an X-ray image sensory system, and wherein the components with less tolerance to the x-ray damage are placed on the side of the substrate board to avoid the direct exposure to the X-ray. Hence, the system could prolong the life span.

For the aforementioned purpose, the present invention provides an X-ray image sensory system. The X-ray image sensory system includes an X-ray conversion module for converting the input X-ray, a sensory component for detecting the converted signals, a substrate board, a buffer and an analog-to-digital converter. The X-ray conversion module and the image sensory component are on the side of the substrate board facing the input X-ray, and the buffer and the analog-to-digital converter are on the other side of the substrate board.

These and other objectives of the present invention will no doubt become obvious to those of ordinary skill in the art after reading the following detailed description of the preferred embodiment which is illustrated in the various figures and drawings.

### BRIEF DESCRIPTION OF THE DRAWINGS

FIG. 1 is a schematic diagram of an embodiment according to the present invention.

FIG. 2 is a schematic diagram of another embodiment of the present invention.

### DETAILED DESCRIPTION OF THE PREFERRED EMBODIMENT

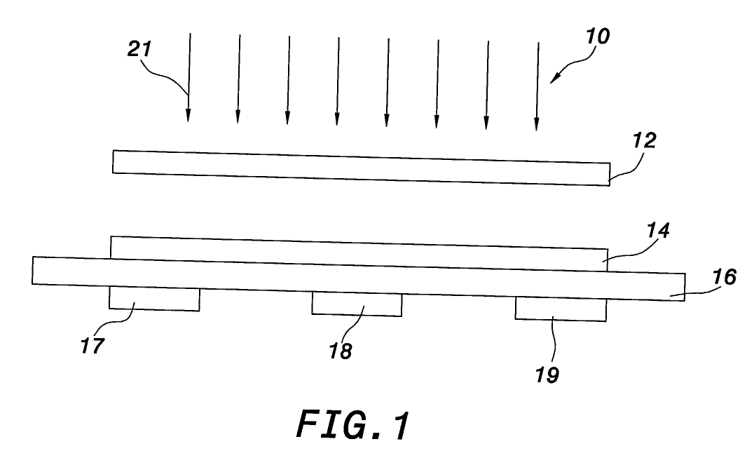

FIG. 1 shows a schematic diagram of a preferred embodiment 10 of the present invention. The X-ray image sensory system 10 includes an X-ray conversion module 12, a CMOS image sensory component 14, a substrate board 16, a buffer 17, an analog-to-digital converter (ADC) 18, and a sequencing control circuit 19. The X-ray conversion module 12 could be either the direct or indirect type. An indirect conversion means that the X-ray 21 is first converted to visible light signals, then to electrical signals, while in direct conversion the X-ray 21 is directly converted to electrical signals. The X-ray conversion module 12 is connected to the CMOS image sensory component 14, so that the CMOS image sensory component 14 can detect the electrical signals converted from the input X-ray 21. The electrical signals are amplified by the buffer 17, transmitted to ADC 18, and then output by the sequencing control circuits 19. The buffer 17, ADC 18 and the sequencing control circuit 19 are all electrically connected by a printed circuit board (not shown) on the substrate board 16. The connection allows the electrical signals converted from the X-ray 21 to be amplified, analogically-to-digitally converted, and read out sequentially. The buffer 17, ADC 18, and the sequencing control circuit 19 can also be electrically connected by the conductive wires, wire bonds, conductive bumps, Ball Gate Array (BGA), or conductive tape, all of which are not shown in the figures.

The X-ray conversion module 12 and the CMOS image sensory component 14 are on the side of the substrate board 16 facing the input X-ray 21. The buffer 17, ADC 18 and the sequencing control circuit 19 are on the other side of the substrate board 16. Because the buffer 17, ADC 18 and the sequencing control circuit 19 are less tolerant to the X-ray damage than the CMOS image sensory component 14, they are placed on the other side of the substrate board 16 to avoid the direct exposure to the X-ray 21. This is to ensure the normal operation of the image sensory system 10. For better protection of the buffer 17, ADC 18 and the sequencing control circuit 19, the substrate board 16 is made of the material highly tolerant to the X-ray 21. Furthermore, the components of the image sensory system 10, including the X-ray conversion module 12, CMOS image sensory component 14, buffer 17, ADC 18 and sequencing control circuit 19, are all manufactured separately, then connected to the substrate board 16 later. Separately manufacturing each component respectively is to avoid the low yield problem that is usually associated with the SOC technology. Also, all the components are replaceable, therefore increasing the flexibility of the present invention image sensory system 10.

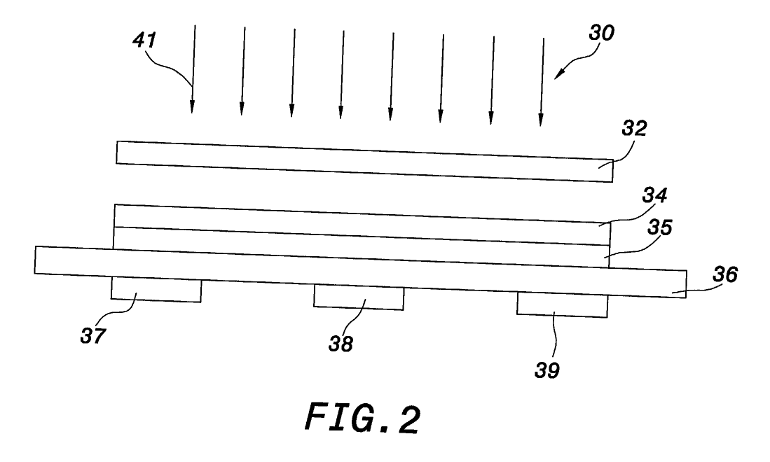

FIG. 2 shows a schematic diagram of another image sensory system 30 of the present invention. The second embodiment 30 includes an X-ray conversion module 32, a CMOS image sensory component 34, an X-ray shield layer 35, a substrate board 36, a buffer 37, an analog-to-digital converter (ADC) 38, and a sequencing control circuit 39. The X-ray conversion module 32 could be either direct or indirect type. An indirect conversion means that the X-ray 41 is first converted to the visible light, then to electrical signals, while direct conversion converts the X-ray 41 directly to electrical signals. The X-ray conversion module 32 is connected to the CMOS image sensory component 34, so that the CMOS image sensory component 34 can detect the electrical signals converted from the input X-ray 41. The electrical signals are amplified by the buffer 37, transmitted to ADC 38, then outputted by the sequencing control circuit 39. The buffer 37, ADC 38 and the sequencing control circuit 39 are all electrically connected by a printed circuit board (not shown) on the substrate board 36. The connection allows the electrical signals converted from the X-ray 41 to be amplified, analogically-to-digitally converted, and read out sequentially. The buffer 37, ADC 38, and the sequencing control circuit 39 can also be electrically connected by the conductive wires, wire bonds, conductive bumps, Ball Gate Array (BGA), or conductive tape (not shown).

The X-ray conversion module 32 and the CMOS image sensory component 34 are on the side of the substrate board 36 facing the input X-ray 41. The buffer 37, ADC 38 and the sequencing control circuit 39 are on the other side of the substrate board 36. Because the buffer 37, ADC 38 and the sequencing control circuit 39 are less tolerant to the X-ray than the CMOS image sensory component 34, which therefore are placed on the other side of the substrate board 36 to avoid the direct exposure to the X-ray 41. This is to ensure the normal operation of the image sensory system 30. For better protection of the buffer 37, ADC 38 and the sequencing control circuit 39, the substrate board 36 is made of the material that is highly tolerant to the X-ray 41. To rid off the impact of the X-ray 41 on the buffer 37, ADC 38 and the sequencing control circuit 39, the image sensory system 30 further includes an X-ray shield layer 35 between the CMOS image sensory component 34 and the substrate board 36. This provides an enhanced protection to the buffer 37, ADC 38 ad the sequencing control circuit 39 on the other side of the substrate board 36.

Furthermore, the components of the image sensory system 30, including the X-ray conversion module 32, CMOS image sensory component 34, the buffer 37, ADC 38 and the sequencing control circuit 39, are all manufactured separately, then connected to the substrate board 36 later. Separately manufacturing above components is to avoid the low yield problem that is usually associated with the SOC technology. Also, all the components are replaceable, thereby increasing the flexibility of this preferred embodiment 30.

Compared to the prior arts, the present invention places the components more susceptible to the X-ray damage on the back side of the substrate board to avoid the direct exposure to the X-ray. These less-tolerant components include a buffer, an analog-to-digital converter, and a sequencing control circuit. This design allows a better protection to the components as well as reducing the size of the entire system. In addition, because the buffer and the image sensory component are on the opposite sides of the substrate board, the converted signals (electrical signals) can be directly transmitted and amplified. The shortened transmission distance can reduce the signal decay or interference distortion. Furthermore, the components of the system are all manufactured separately, then assembled together on the substrate board later, thus avoiding the low yield problem that is usually associated with the SOC technology. Also, all the components are replaceable for the purpose of increasing the flexibility of the system.

Those skilled in the art will readily observe that numerous modifications and alterations of the device may be made while retaining the teachings of the invention.

Accordingly, the above disclosure should be construed as limited only by the metes and bounds of the appended claims.

What is claimed is:

1. An X-ray image sensory system, comprising:
an X-ray conversion module for converting input X-ray;
an image sensory component connected to the X-ray conversion module for detecting the converted X-ray signals;
a substrate board;
a buffer;
an analog-to-digital converter; and
a sequencing control circuits; wherein the X-ray conversion module and the image sensory component are on one side of the substrate board, while the buffer, the analog-to-digital converter, and the sequencing control circuit are on the other side of the substrate board.

2. The X-ray image sensory system as in claim 1, wherein the x-ray conversion module converts the input X-ray to electrical or visible light signals.

3. The X-ray image sensory system as in claim 1, wherein the image sensory component transmits the electrical signals to the buffer.

4. The X-ray image sensory system as in claim 1, wherein the substrate board is made of a single material or compound materials.

5. The X-ray image sensory system as in claim 1, further comprising an X-ray shield layer disposed between the image sensory component and the substrate board.

6. The X-ray image sensory system as in claim 1, wherein the buffer, the analog-to-digital converter and the sequencing control circuit are connected with each other by at least a wirebond, a conductive bump, a Ball Gate Array or a conductive tape.

7. The X-ray image sensory system as in claim 1, wherein the substrate board further includes a printed circuit board for connecting the buffer, the analog-to-digital converter and the sequencing circuit.

8. The X-ray image sensory system as in claim 1, wherein the buffer, the analog-to-digital converter and the sequencing control circuits are all connected with a electrical wire.

9. The X-ray image sensory system as in claim 1, wherein the image sensory component is a CMOS component.

10. The X-ray image sensory system as in claim 1, wherein the image sensory component, the X-ray conversion module, the buffer, the analog-to-digital converter, and the sequencing control circuit are manufactured separately, then assembled on the substrate board.

11. The X-ray image sensory system as in claim 1, wherein the substrate board is made of material that is tolerant to the input X-ray.
